(19) United States
(12) Patent Application Publication
(10) Pub. No.: US 2026/0070230 A1
(43) Pub. Date: Mar. 12, 2026

(54) A SKYSCRAPER FAÇADE INSPECTION ROBOT AND A BUILDING MAINTENANCE ROBOT AND SYSTEM

(71) Applicant: Quentin Tsang, New Territories, Hong Kong (CN)

(72) Inventor: Quentin Tsang, New Territories, Hong Kong (CN)

(21) Appl. No.: 19/126,505

(22) PCT Filed: Aug. 1, 2023
(86) PCT No.: PCT/CN2023/110583

§ 371 Date: May 1, 2025

(51) Int. Cl. B25J 11/00; B08B 7/00; B08B 7/02; B25J 9/16; B25J 19/02; E04G 23/00

(52) U.S. Cl. CPC B25J 11/0085; B08B 7/0042; B08B 7/028; B25J 9/1679; B25J 19/023; E04G 23/002

(57) ABSTRACT

A system for a building maintenance robot comprising a chassis, a locomotion system coupled to the chassis, the locomotion system configured to facilitate movement of the robot, one or more tools coupled to the chassis, the one or more tools configured to allow the robot to perform one or more maintenance tasks, a controller in electrical communication with the locomotion system and the one or more tools, the controller configured to control the locomotion system to cause movement of the robot and control the one or more tools to perform the one or more maintenance tasks.

### TECHNICAL FIELD

The present invention relates to a building maintenance robot for performing one or more maintenance tasks on a building. The present invention may also relate to a building maintenance system or a skyscraper façade inspection robot.

### BACKGROUND

A building and its components such as a building façade, may suffer from several maintenance issues. These maintenance issues can lead to damage to the building if left unattended. Some common maintenance issues may be, for example, aging or cracked sealant on curtain walls, water leakage through the façade, scratches or chips on glass panes, hardware, and hinges etc. Regular maintenance i.e., servicing of buildings is required to reduce damage due to some or all of the above maintenance issues.

Servicing i.e., maintenance, can include several tasks, such as inspection, cleaning, and repair. Regular inspection of a building, in particular inspection of the outer portions of a building e.g., a building façade, are required to identify these maintenance issues. Ignoring these issues or not checking for such maintenance issues can lead to damage of the building or parts of the building. Repairing damaged portions of buildings can be costly and time consuming.

Various maintenance tasks (i.e., servicing tasks) are required to be performed regularly to identify and rectify any maintenance issues that have arisen on buildings. Regular maintenance is required for all buildings but is especially challenging in skyscrapers or other tall buildings due to their size. Often highly skilled and highly trained human operators are required to perform these maintenance tasks. Performing maintenance tasks, especially on skyscrapers, can be challenging, time consuming, costly and in some instances may be hazardous to maintenance personnel performing these maintenance tasks.

### SUMMARY OF THE INVENTION

The present invention relates to a building maintenance robot that is configured to perform one or more maintenance tasks. The robot may be configured to perform several maintenance tasks either separately, consecutively or concurrently. Some example maintenance tasks can include cleaning, inspecting and repairing. The robot may be fully autonomous such that the robot can be programmed with a route to follow on a building façade and perform maintenance tasks according to a schedule of maintenance tasks.

In accordance with a first aspect of the present invention, there is provided a building maintenance robot comprising:
a chassis,
a locomotion system coupled to the chassis, the locomotion system configured to facilitate movement of the robot, one or more tools coupled to the chassis, the one or more tools configured to allow the robot to perform one or more maintenance tasks,
a controller in electrical communication with the locomotion system and the one or more tools, the controller configured to:
control the locomotion system to cause movement of the robot and;
control the one or more tools to perform the one or more maintenance tasks.

In an embodiment, the one or more tools comprises one or more of:
a cleaning tool configured to clean a portion of a building,
an inspection tool configured to perform one or more inspections to identify one or more defects on a portion of a building,
a repair tool configured to perform one or more repair functions on a portion of a building.

In an embodiment, the robot comprising a plurality of tools configured to allow the robot to perform multiple maintenance tasks, and wherein the plurality of tools comprise two or more of: a cleaning tool, an inspection tool, a repair tool.

In an embodiment, at least one cleaning tool, at least one inspection tool and at least one repair tool, and the controller is configured to receive data from the inspection tool and identify one or more defects based on processing the received data from the inspection tool, and the controller further configured to control operation of the cleaning tool and the repair tool.

In an embodiment, the cleaning tool comprises at least one of:
a spray gun configured to spray a cleaning substance onto a portion of the building,
a rolling wheel and a cleaning agent dispenser,
an ultrasonic cleaning device configured to clean a portion of a building by applying ultrasonic waves,
a dry ice blasting device configured to apply dry ice pellets using compressed air onto a portion of a building,
a laser cleaning device configured to apply a focussed laser beam to a portion of a building.

In an embodiment, the inspection tool comprises at least one of:
an infrared ray device configured to utilise infrared signals to identify one or more defects on a portion of building,
a water jet device configured to utilise a water jet to identify one or more defects,
a caulking test device configured to identify a defect in a caulking material used on a portion of a building façade,
an electrical scanning device configured to measure an electrical property and the electrical scanning device configured to detect and measure deterioration in a portion of a façade of the building,
a laser device configured to use a laser and detect a fault in a portion of the façade of the building,
a mechanical vibration device configured to apply vibrations to a portion of the façade and determine one or more defects based on the measured vibrations,
a pH detector configured to sense pH of a portion of a façade and determine a defect based on the detected pH,
a chemical detection device configured to detect one or more chemicals and detect one or more defects based on the detected chemicals.

In an embodiment, at least one camera, the camera mounted on the chassis and configured to capture one or more images of a portion of the building.

In an embodiment,
the camera is an inspection tool,
the camera is arranged in electrical communication with the controller,
the camera configured to capture one or more images of a portion of the façade of the building
the controller configured to receive the one or more captured images of a portion of the façade of the building from the camera,
the controller configured to apply chromo-inspection technique or object identification techniques to detect one or more defects visible in the one or more captured images.

In an embodiment, the controller is configured to detect a plurality of wavelengths within the captured images to identify one or more defects in a portion of the façade of the building.

In an embodiment, a pair of cameras, the pair of cameras are mounted on a front portion of the chassis, the pair of cameras being spaced apart from each other at a predefined distance.

In an embodiment, the pair of cameras configured to capture a video stream and transmit video stream to the controller,
the controller configured to receive the video stream,
the controller configured to:
process the video stream to identify features of the façade and identify obstacles within the video stream, control the locomotion system to move the robot along the façade of the building based on the identified features and obstacles, or;
detect one or more defects based on the identified one or more features of the façade.

In an embodiment, the controller is configured to:
receive measured data from the inspection tool,
process the received data,
identify one or more defects identified based on the received data from the inspection tool, wherein the one or more defects
may be any one or more of:
cracks in the façade,
gaps between glass and windows, or gaps between a window frame and the building façade,
aging of the façade,
scratches or cracks in window frames or window glass,
leaks in the building façade or window frames,
peeling of a façade,
deformation of the façade,
deterioration of the façade material or window frame material or glass,
damage to UV coating of the façade,
loose or hollow areas in the building façade,
rust on the façade or window frames,
change in acidity or alkalinity of the façade material,
mould or algae growth on the façade or window frame or glass.

In an embodiment, the repair tool comprises at least one of: a caulking gun configured to apply a filler material to a portion of a façade of the building to fill in cracks or gaps identified on the façade or gaps between the window frame and façade, a polishing tool configured to polish the façade or window frames to remove rust, dirt or other surface contaminants, a glass buffing tool configured to buff glass to repair scratches or marks on a window glass.

In an embodiment, the robot comprising:
a plurality of arms,
each arm being moveably connected to the chassis and extending outward from the chassis,
the cleaning tool being removably connected to or removably mounted on an arm,
the inspection tool being removably connected to or removably mounted on an arm, and;
the repair tool being removably connected to or removably mounted to an arm.

In an embodiment, each arm is an articulating arm configured to articulate in multiple directions.

In an embodiment, each arm comprises at least two joints, a first joint connecting a first arm member to the chassis and a second joint connecting the first arm member to a second arm member, the second arm member being moveable relative to the first arm member by the second joint.

In an embodiment, the second arm member of one or more of the plurality of arms comprising a tool mount to removably receive one of: the cleaning tool, inspection tool or repair tool.

In an embodiment, the robot comprises at least two locomotion arms moveably coupled to the chassis,
the locomotion system comprising the two locomotion arms,
the controller configured to control movement of the locomotion arms, such that in use the controller configured to alternatingly providing a drive signal to the locomotion arms to cause the locomotion arms to move in an alternating manner, and;
wherein alternating movement of the locomotion arms cause the robot to move along a façade of the building.

In an embodiment, each locomotion arm comprises a foot and an attachment mechanism positioned on the base of the foot, in use, the attachment mechanism attaching each locomotion arm to the façade of the building as the robot is moving across the façade.

In an embodiment, the attachment mechanism comprising a plurality of suction cups to attach to a façade of the building.

In an embodiment, the robot comprises at least six arms attached to the chassis and extending outward from the chassis, four of the at least six arms are locomotion arms,
two arms of the at least six arms comprise tool mounts to removably mount or attach a tool to each of the two arms, wherein the tool comprises one of a cleaning tool, an inspection tool or a repair tool.

In an embodiment, in use the controller is configured to:
control movement of a first pair of diagonally opposite arms while maintaining the second pair of diagonally opposite arms stationary, and;
alternatively control movement of the first pair of diagonally opposite arms and second pair of diagonally opposite arms.

In an embodiment, each of the locomotion arms comprises a foot with a plurality of suction cups disposed on each foot,
the suction cups are fluidly coupled to a vacuum pump system that is configured to create to suction in the suction cups when switched on,
the controller arranged in electrical communication with the vacuum pump system, and the controller configured to activate
the vacuum pump system to create suction in the suction cups for the stationary diagonally opposite arms and deactivate
the vacuum pump system to switch off suction in the suction cups for the diagonally opposite pair arms that are moving.

In an embodiment, the vacuum pump system comprises at least two pumps, each vacuum pump being fluidly coupled to the suction cups on a pair of diagonally opposite pair of arms.

In an embodiment, the locomotion system further comprises:
a cable assembly,
the cable assembly comprising at least two cables, and a winch linked to each cable,
the two cables being coupled to the chassis,
the controller configured to: control the winch to raise or lower the cables to move the robot vertically.

In an embodiment, the locomotion system comprises:
a first vertical cable and a second vertical cable,
a first winch and a second winch, the first cable coupled to the first winch and the second cable coupled to the second winch,
a horizontal cable extending between the vertical cables, the horizontal cable coupled to each vertical cable by a wheel
that is moveable along the vertical cable,
the horizontal cable coupled to the chassis such that the chassis is moveable on the façade and along the horizontal cable.

In an embodiment, the locomotion system comprises:
a cable,
a pair of winches, a free end of the cable being clamped in each winch,
the winches arranged in electrical communication with the controller,
the winches configured to adjust the length of the cable, and;
the chassis suspended from the cable and moveable on the façade and along the cable.

In accordance with another aspect, there is provided a building maintenance system comprising:
a building maintenance robot as per any one example of the first aspect of the building maintenance robot,
a computing system in electronic communication with the robot, the computing system configured to receive data regarding
the one or more maintenance tasks performed by the robot,
the computing system configured to perform at least one or more of:
machine learning analysis on the received data to learn from maintenance tasks performed and adjust the types or frequency of maintenance tasks,
generate a maintenance schedule defining the number of maintenance tasks to be performed, frequency of these tasks, and location of maintenance tasks on the building façade,
execute a pre-programmed maintenance schedule or the generated maintenance schedule, generate mathematical models that simulate the deterioration rate of the building façade based on the received maintenance task data,
identify building façade deterioration patterns based on the received maintenance task data,
identify components of the façade that require the most maintenance, calculate costs for performing maintenance and determine the most cost-effective maintenance schedule.

In an embodiment, the computing system comprises a remote server in wireless communication with the robot or the computing system comprising the controller of the robot.

In another aspect of the present invention, there is provided a skyscraper façade inspection robot comprising:
a chassis,
a locomotion system coupled to the chassis, the locomotion system configured to facilitate movement of the robot, one or more tools coupled to the chassis, the one or more tools configured to allow the robot to perform one or more maintenance tasks,
a controller in electrical communication with the locomotion system and the one or more tools, the controller configured to:
control the locomotion system to cause movement of the robot;
control the one or more tools to perform the one or more maintenance tasks; and, wherein the one or more tools comprises one or more of:
a cleaning tool configured to clean a portion of a building,
an inspection tool configured to perform one or more inspections to identify one or more defects on a portion of a building,
a repair tool configured to perform one or more repair functions on a portion of a building; and,
wherein the robot comprising a plurality of tools configured to allow the robot to perform multiple maintenance tasks, and
wherein the plurality of tools comprise two or more of: a cleaning tool, an inspection tool, a repair tool; and wherein the robot further comprises at least one cleaning tool, at least one inspection tool and at least one repair tool, and the controller is configured to receive data from the inspection tool and identify one or more defects based on processing the received data from the inspection tool, and the controller further configured to control operation of the cleaning tool and the repair tool.

### BRIEF DESCRIPTION OF THE DRAWINGS

One or more embodiments of a building maintenance robot will now be described, by way of example, with reference to the accompanying drawings in which:

FIG. 1 illustrates an example of a building maintenance robot.

FIG. 2 illustrates a top view of an example building maintenance robot.

FIG. 3 illustrates the bottom view of the building maintenance robot shown in FIG. 2.

FIG. 4 illustrates a side of the building maintenance robot shown in FIG. 2.

FIG. 5 illustrates a front view of the building maintenance robot of FIG. 2.

FIG. 6 illustrates an example foot and an associated attachment mechanism of the building maintenance robot.

FIG. 7 illustrates the four locomotion arms at rest with suction for all four attachment mechanisms being activated.

FIG. 8 illustrates the preparation for a first step by the robot where a first diagonally opposite pair of arms has suction being deactivated.

FIG. 9 illustrates a first step by the robot.

FIG. 10 illustrates the completion of the first step where the suction on all four attachment mechanisms is activated.

FIG. 11 illustrates the preparation for a second step by the robot where a second diagonally opposite pair of arms has suction deactivated.

FIG. 12 illustrates the completion of the second step where suction for all arms is activated.

FIG. 13 illustrates a first example of a locomotion system including vertical cables and a horizontal cable, wherein this locomotion system defines a cartesian locomotion system.

FIG. 14 illustrates a second example of a locomotion system including a single cable wherein this locomotion system defines a polar locomotion system.

FIG. 15 illustrates an example of a building maintenance robot having two tool arms and four locomotion arms.

FIG. 16 illustrates an example robot with a pair of cameras on a front face.

FIG. 17 illustrates a building maintenance system and its components.

### DETAILED DESCRIPTION OF THE PREFERRED EMBODIMENTS

Buildings, especially skyscrapers or other such tall buildings can suffer from several issues. These issues i.e., maintenance issues can lead to damage to the building or its components such as for example window frames or windows or the façade etc. Some common issues with buildings will now be described.

Building, in particular skyscrapers often require several tests and maintenance tasks. Some of the most common maintenance tasks on buildings especially large buildings like skyscrapers are monitoring aging or cracking sealant on curtain walls, water leakage testing, inspection of water leakage, inspection of scratches on glass panes or hinges or other building components, inspection of exterior metal panel coatings, testing of thermal insulation e.g., of glass panels and/or cladding or façade materials. Additionally further maintenance tasks may include cleaning tasks such as for example regular cleaning of the façade, window glass panes etc., cleaning of gaps e.g., between windows and façade, polishing of window frames. Some example maintenance tasks that are required may also include repair tasks such as replacing sealant or repairing leak sources, repairing scratches on windows or window frames or other components.

These maintenance tasks are currently often performed by trained human operators. These operators require extensive training and utilise specialised equipment to climb up or descend down from these buildings to perform one or more maintenance tasks e.g., like the ones described earlier. These operators often require very expensive, bulky and highly specialised equipment to perform one or more of the maintenance tasks. The equipment needs to be hoisted to heights where the operators are working. The height of skyscrapers and the nature of the work is highly risky and there is a risk of serious injury or death for the operators. Maintenance tasks are required to performed with regularity to prevent damage to the building and maintain integrity of the building and its components. Regular maintenance schedules are required to inspect and perform cleaning or repair or remedial work to prevent structural damage to the building. Each time the operators have to work puts these operators at risk. This can lead to reduced regularity (i.e., reduced consistency) of performing these tasks to reduce operator risk. Further, inspection of maintenance tasks can be expensive and unsafe since human operators again have to be suspended off a building to perform these inspections.

The highly specialised nature of the work can also make performing these maintenance tasks expensive due to use of costly equipment and/or expensive set ups e.g., scaffolding, or suspended platforms etc. Additional expense is also due to hazard pay for the operators. Pedestrians are also at risk due to the risk of falling equipment or falling debris as these tasks are performed. Often the building or large parts of the building have to be isolated or shut down in order to allow operators to perform these maintenance and servicing tasks, which can lead to lost revenues. The current human operator way of performing building maintenance especially, for example maintenance of skyscraper facades can be expensive, inefficient, and hazardous to the operators. Additionally, maintenance is not consistent due to hazards and costs which can lead to degradation of the building further adding to costs and the set-up costs e.g., the highly specialised equipment can also make the whole process costly and less consistent.

The present invention relates to a building maintenance robot. The building maintenance robot is an automated device that is configured to perform one or more building maintenance tasks. The building maintenance robot is autonomously moveable along a building façade or may be manually controlled to move along a building façade to perform one or more maintenance tasks such as cleaning, inspection or repair.

In one example configuration the building maintenance robot comprises: a chassis, a locomotion system coupled to the chassis, the locomotion system configured to facilitate movement of the robot, one or more tools coupled to the chassis, the one or more tools configured to allow the robot to perform one or more maintenance tasks, a controller in electrical communication with the locomotion system and the one or more tools, the controller configured to: control the locomotion system to cause movement of the robot and; control the one or more tools to perform the one or more maintenance tasks.

The building robot may be an automated robot that can be programmed with a predefined path or route about a building. The robot may be programmed to automatically perform one or more maintenance tasks on the building as the robot moves along the façade of the building.

The robot of the present invention is advantageous because it is cost effective, efficient, has improved accessibility i.e., can access various parts of the buildings, and is safer due to the use of the robot instead of human operators. The cost effective and simpler, safer robot also allows for a more consistent maintenance or servicing schedule to be maintained. The robot can also provide a safer, cheaper device for inspecting maintenance tasks that have been performed and a safer, cost-effective and more efficient device to assess or inspect a building.

The present invention further relates to a building maintenance system comprising a building maintenance robot and a computing system. The robot may be in electronic communication, for example two-way wireless communication with the computing system. The maintenance robot may be configured to transmit performance of one or more maintenance tasks to the computing system. The computing system may log the one or more maintenance tasks performed by the robot to track performance of one or more maintenance tasks. The computing system may be configured to perform analytics on the data related to the performance of the one or more maintenance tasks by the robot. The computing system may be configured to transmit instructions to the robot. The instructions may include where and when to perform one or more maintenance tasks. The computing system may further be configured to transmit one or more routes for the robot to follow along a building façade. The computing system may be a computing system 310 e.g., a server or may be incorporated into the robot.

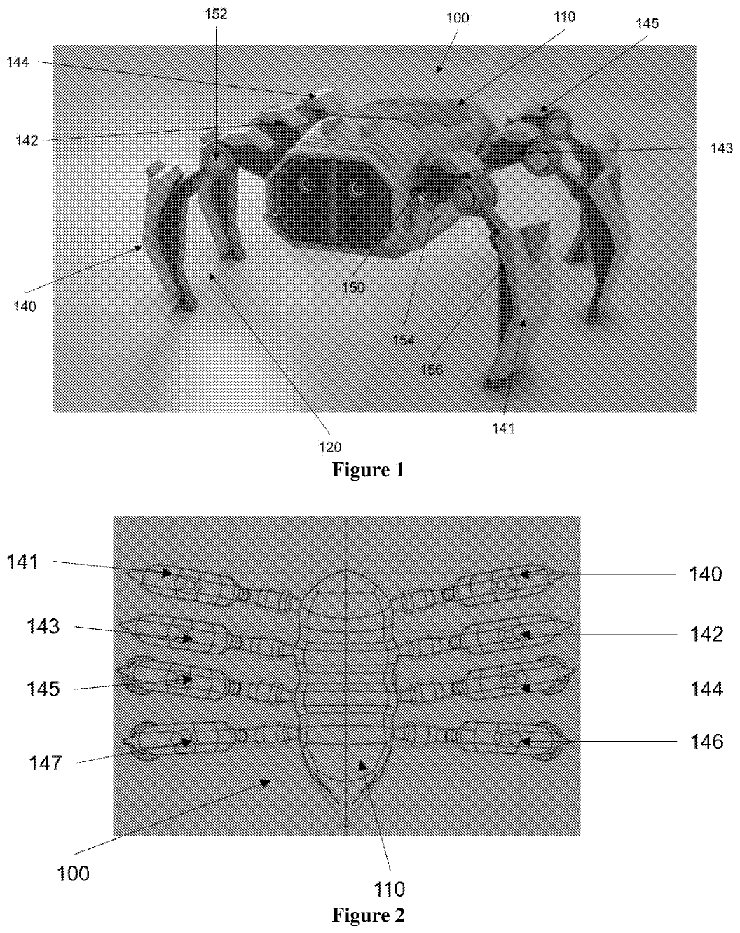

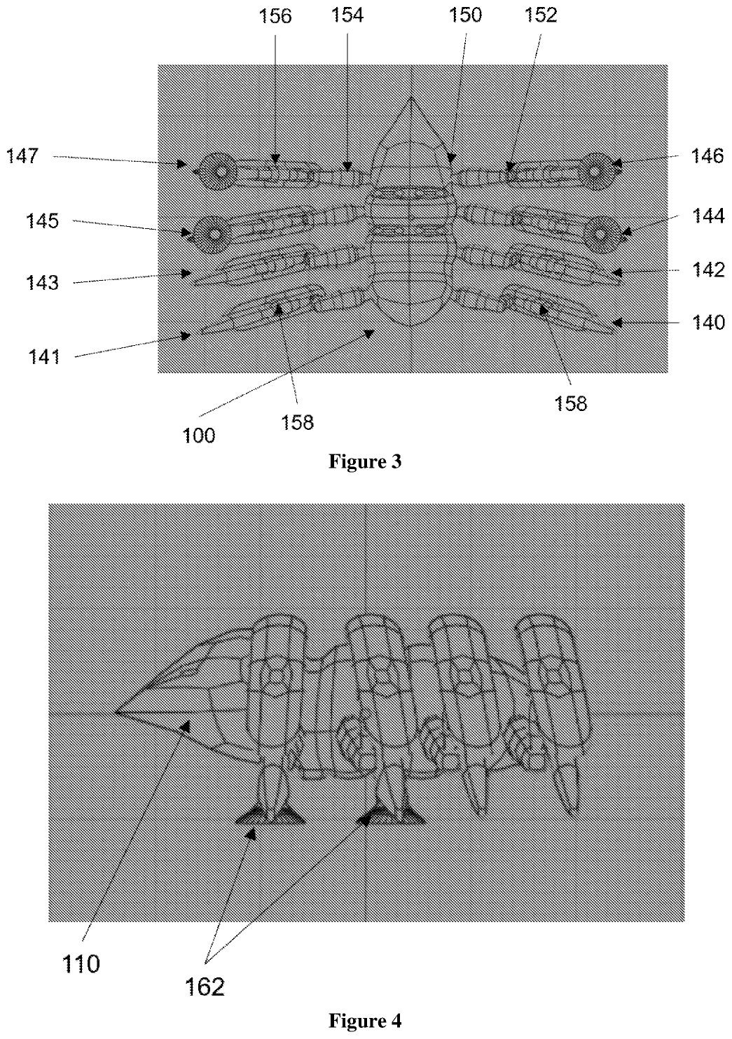

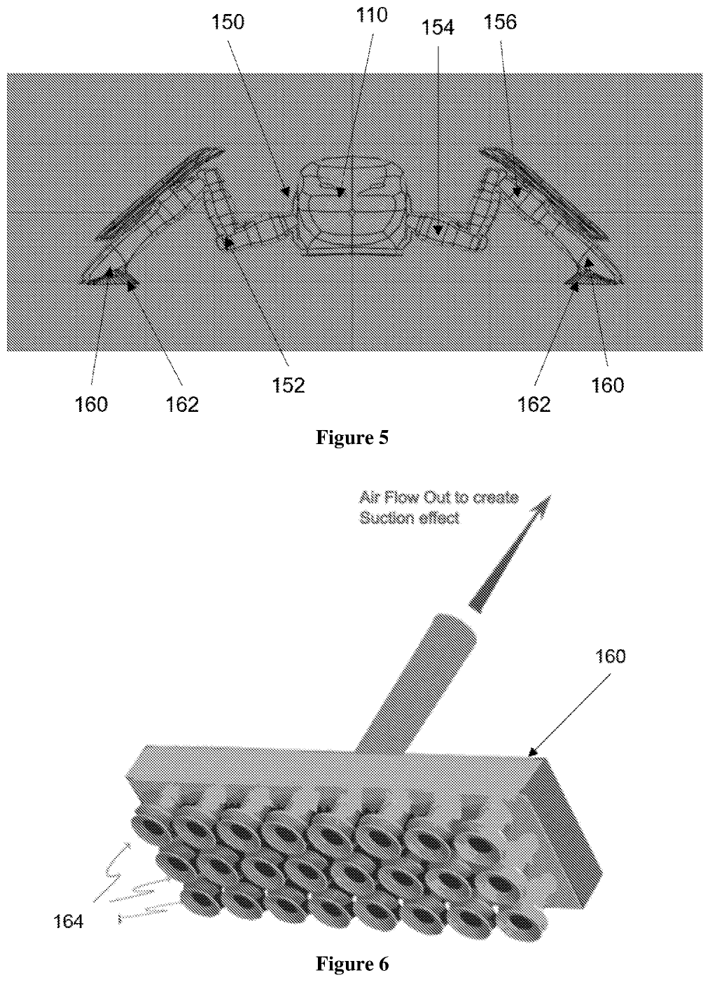

FIGS. 1 to 5 illustrate an example form of a building maintenance robot 100. The robot 100 comprises a chassis 110, a locomotion system 120 coupled to the chassis and one or more tools coupled to the chassis 110. The locomotion system 120 is configured to facilitate movement of the robot about a building façade. The building maintenance robot 100 further comprises a controller 130 in electrical communication i.e., electrically coupled to the locomotion system 120 and the one or more tools. The controller 130 is configured to: control the locomotion system to cause movement of the robot and; control the one or more tools to perform the one or more maintenance tasks.

In use, the maintenance robot may be deployed on a building, e.g., on a building façade and may be configured to move along the building façade and perform one or more maintenance tasks.

The one or more tools comprises one or more of: a cleaning tool configured to clean a portion of a building, an inspection tool configured to perform one or more inspections to identify one or more defects on a portion of a building, a repair tool configured to perform one or more repair functions on a portion of a building.

The robot 100 comprising a plurality of tools configured to allow the robot to perform multiple maintenance tasks, and wherein the plurality of tools comprise two or more of: a cleaning tool, an inspection tool, a repair tool. In one example configuration the robot comprises at least one cleaning tool, at least one inspection tool and at least one repair tool mounted to or coupled to the chassis 110. The tools may be removably coupled or mounted onto the chassis. Alternatively, the tools may be permanently attached to the chassis or may be integrated into the chassis.

The controller 130 comprises at least a processor 132 e.g., a microprocessor and a memory unit. The memory unit 134 may comprise a read/write memory. In one example the memory unit 134 may comprise a solid-state memory. The controller may comprise one or more removable memory elements such as for example a USB or SD card or other removable memory elements. The robot 100 may comprise an appropriate opening or slot to receive the removable memory unit. The memory unit may further store computer readable and executable instructions that define one or more controller functions. The processor 132 may be configured to execute the stored instructions to perform the various functions described herein.

The controller 130 may further comprise a wireless communication module 136. The wireless communication module may be configured to wirelessly communicate with one or more other components. The wireless communication module may comprise multiple communication units each one programmed to use a different communication protocol. For example, the module 136 may be configured to operate with Wi-Fi, Bluetooth and/or Cellar e.g., GSM.

The robot 100 may comprise a plurality of arms 140. Each arm being moveably connected to the chassis 110 and extending outward from the chassis 110. The tools may be removably connected to or removably mounted to an arm. For example, the cleaning tool being removably connected to or removably mounted on an arm, the inspection tool being removably connected to or removably mounted on an arm, and the repair tool being removably connected to or removably mounted to an arm.

The robot 100 may comprise at least two locomotion arms moveably coupled to the chassis 110. The locomotion system comprising the two locomotion arms. The controller 130 is configured to control movement of the locomotion arms to move the robot along the façade of a building. In one example the controller 130 is configured to alternatingly providing a drive signal to the locomotion arms to cause the locomotion arms to move in an alternating manner to move the robot 100 along a façade of the building.

In one example configuration the robot 100 comprises at least six arms. At least four of the six arms are locomotion arms that are controlled by the controller to move the robot along the façade of a building. At least two arms of the six arms are configured to support one or more tools. In one example, the two tool arms i.e., arms configured to support the tools, may comprise tool mounts to removably mount or attach a tool to each of the two arms, wherein the tool comprises one of a cleaning tool, an inspection tool or a repair tool.

In the illustrated form as shown in FIGS. 2 to 5, the robot 100 comprises eight arms 140, 141, 142, 143, 144, 145, 146, 147. Each arm 140-147 may be an articulating arm configured to articulate in multiple directions. Each arm 140-147 may be omnidirectionally articulatable.

The locomotion arms may be coupled to one or more actuators 148 e.g., servo motors or stepper motors. In one example each locomotion arm is coupled to an actuator e.g., a motor. The motor 148 of each locomotion is controlled by the controller 130. The controller 130 is configured to provide drive signals to each actuator 148 e.g., each motor, as shown in FIG. 17. The actuators 148 may be independently controlled by the controller 130 to move each arm independently.

In illustrated form each arm 140-147 comprises at least two joints 150, 152. Each arm may comprise a first arm member 154 and a second arm member 156. A first joint 150 connecting a first arm member 154 to the chassis 100. The second joint 152 connecting the first arm member 154 to a second arm member 156. The second arm member 156 is moveable relative to the first arm member 154 by the second joint 156.

The second arm member 156 of one or more of the plurality of arms may comprise a tool mount to removably receive one of: the cleaning tool, inspection tool or repair tool.

The first member 154 may be coupled to the chassis 100 by a ball and socket joint 150. The ball joint 150 allows the first member 154 (and hence the arm) to move in an omni directional manner. This improves the mobility of the robot. Each arm 140-147 is independently moveable and independently articulatable. This is advantageous as it allows for improved movement of the robot.

In the illustrated form the robot comprises four tool arms 140, 141, 142, 143. Each tool arm 140-143 comprises a tool mount 158 or another mounting structure to receive and retain a tool. The tool mount 158 may comprise a clamp or a clip or a slot or any other suitable connector. The tool mount 158 may comprise a mechanical connector and an electrical connector. In use, the tool may be mounted in the mechanical connector and electrically connect to the electrical connector. The electrical connector of the tool mount electrically couples the tool to the controller 130. The controller 130 may be configured to provide control signals to the tool to operate the tool. The controller 130 may be programmed to operate the tool based on one or more predefined maintenance tasks that are required to be performed, for example based on a maintenance or service schedule.

The tool mount 158 on each of the tool arms 140-143 may be configured to allow hot swapping of tools. Tools can be easily attached and removed from the robot. The tools being hot swappable allows a user e.g., a human operator of the maintenance robot to change tools to the most appropriate tool to perform one or more maintenance tasks.

The tool may be any one or more of a cleaning tool, inspection tool or repair tool. In the illustrated form, the front four arms 140-143 are tool arms. The tools may be removably mounted onto the tool arms.

In the illustrated form shown in FIGS. 1 to 5, four arms 144, 145, 146, 147 are locomotion arms that are configured to move the robot about a building façade. The four locomotion arms 144-147 move in an alternating arrangement. The locomotion arms 144-147 may be the four rear arms of the robot 100, as shown in FIGS. 2 to 4. The locomotion arms 144-147 are part of the locomotion system 120.

The locomotion arms each may comprise foot 160. Each foot 160 may comprise an attachment mechanism 162 (i.e., a gripper mechanism) positioned on the base of the foot. In use, the attachment mechanism is configured to attaching each locomotion arm 144-147 to the façade of the building as the robot is moving across the façade. FIG. 6 illustrates an example of the attachment mechanism 162. The attachment mechanism is a suction mechanism. The suction mechanism 162 comprises a plurality of suction cups 164. The suction cups 164 create a vacuum seal between the chassis 110 and the façade surface, allowing the robot to stick to the façade and move about the façade.

The suction cups 164 may be made from a soft, flexible material such as for example silicone or rubber. The suction cups 164 may be equally spaced on the foot of each arm 144-147.

The robot further comprises a vacuum pump system 170. The suction cups 164 are fluidly coupled to the vacuum pump system. The vacuum pump system 170 may comprise one or more pumps. The vacuum pump system may further comprise tubing and control valves. In one example the vacuum pump system 170 may comprise two pumps. Each vacuum pump being fluidly coupled to the suction cups on a pair of diagonally opposite pair of arms

The pump system 170 is in electrical communication with the controller 130. The controller 130 may be configured to activate the vacuum pump system 170 to create suction in the suction cups. The vacuum pump system 170 is activated to create suction force to cause the arms to stick to the façade by suction and deactivated to release the arms.

Optionally, the vacuum pump system may comprise one or more pressure sensors to monitor the vacuum pressure inside the suction cups. The sensors may be positioned on the suction cups or on the foot of the arm. The sensors would provide feedback to the control system to adjust the vacuum pressure as needed to maintain a secure grip on the wall surface. The controller 130 may be configured to manage the vacuum pump system and adjust the suction i.e., vacuum pressure as needed to ensure a secure grip onto the façade.

Optionally, the foot 160 of each arm 144-147 may comprise one or more attachment tapes such as for example Van der Waals force nano tape. Van der Waals force nano tape uses Van der Waals forces to keep attachment between the locomotion arms 144-147 to the façade. The nano tape may be made of polymer nanofiber array. This array may mimic the structure of the hairs on a gecko's toes and function in a similar manner to adhere to the façade when in use. The Van der Waals nano tape may be used in addition to the suction cups. Alternatively, the Van der Waals nano tape may be used as an alternative to the suction cups.

Van der Waals force nano-tape can provide strong adhesion to surfaces, enabling it to be used for climbing and gripping applications. The adhesion strength is proportional to the surface area of the tape in contact with the surface, so the more surface area, the stronger the adhesion. Van der Waals force nano-tape is reusable because it does not leave any residue on the surface when removed.

Van der Waals force nano-tape can adhere to a wide range of surfaces, including smooth and rough surfaces, wet and dry surfaces, and even surfaces in a vacuum. This is an advantage of using the nano tape and suction cups 164 together. This provides a more secure attachment of the robot 100 to the building façade. The tape is made of a durable polymer material that is resistant to wear and tear, making it suitable for long-term use.

The controller 120 is configured to control movement of the locomotion arms 144-147. In use the controller 120 is configured to alternatingly provide a drive signal to the locomotion arms 144-147 to cause the locomotion arms to move in an alternating manner. The alternating movement of the locomotion arms cause the robot to move along a façade of the building. The controller 130 is configured control movement of a first pair of diagonally opposite arms 144, 146 while maintaining the second pair of diagonally opposite arms 145, 147 stationary. The attachment mechanism e.g., the vacuum pump is operated to create suction on the stationary arms 145, 147. The controller is configured to alternatively control movement of the first pair of diagonally opposite arms and second pair of diagonally opposite arms

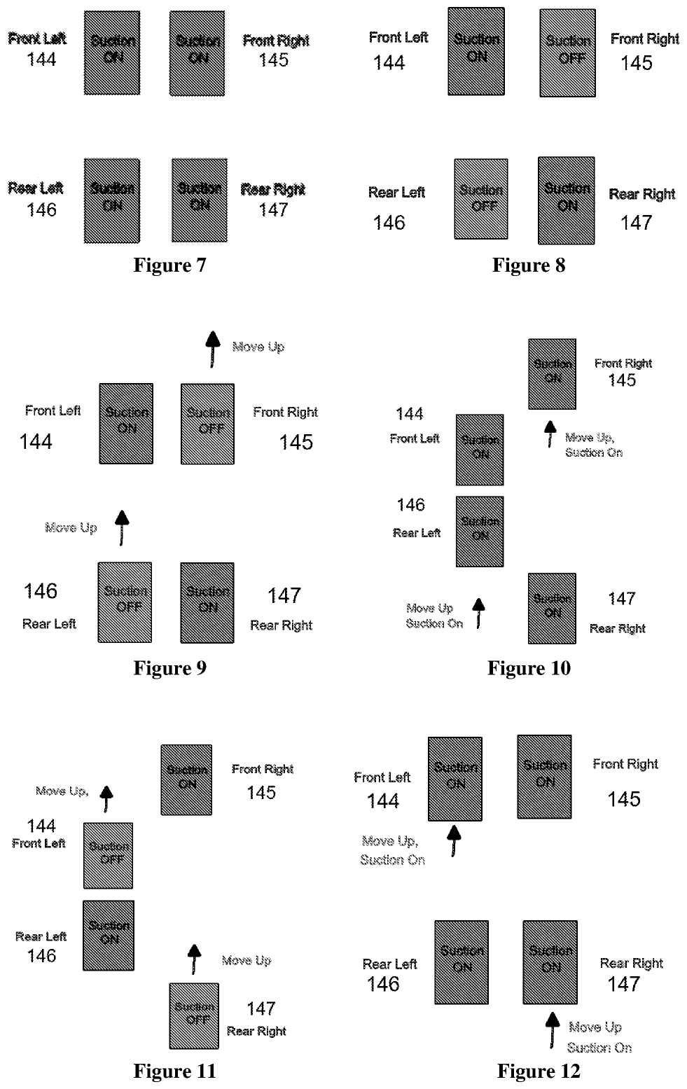

FIGS. 7 to 12 illustrate movement of the robot 100. FIG. 7 illustrates a starting position. In the starting position the locomotion arms 144-147 have suction on by the vacuum pumps. FIG. 8 illustrates the start of movement i.e., start of the robot 100 walking. At the start of the walking diagonal pair 144, 146 of arms have suction turned off to allow them to move. The suction of the second diagonal pair 145, 147 is maintained. FIG. 9 illustrates movement of the first diagonal pair of arms 144, 146. The arms 144, 146 are moved forward while the arms 145, 147 are still attached to the façade. FIG. 10 illustrates the completion of the first step. As shown in FIG. 10, the suction on all arms 144-147 is activated by activating the vacuum pump system. FIG. 11 illustrates the second step by deactivating the suction for the second diagonal pair 145, 147. The arms 145, 147 are moved forward as shown in FIG. 11. FIG. 12 illustrates the conclusion of the second step and the suction is activated for all the arms 144-147. The steps shown in FIGS. 7 to 12 are repeated to move the robot along the façade. The arms are moved in diagonal pairs to move the robot 100 along a building façade.

The locomotion system 120 further comprises a cable assembly. The cable assembly comprising at least two cables, and a winch linked to each cable. The two cables being coupled to the chassis. The controller is configured to: control the winch to raise or lower the cables to move the robot vertically.

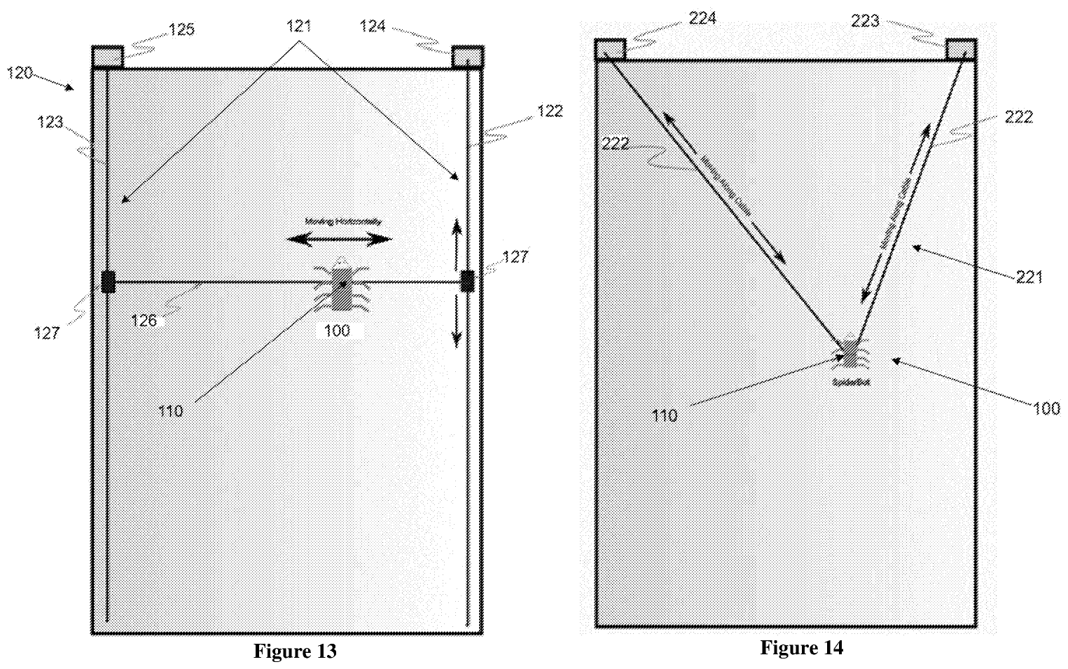

FIG. 13 illustrates a first example configuration of a cable assembly 121. The cable assembly 121 comprises a first vertical cable 122 and a second vertical cable 123. The cable assembly 121 forms part of the locomotion system 120. The cable assembly 121 further comprises a first winch 124 and a second winch 125. The first cable 122 is coupled to the first winch 124. The second cable 123 coupled to the second winch 125.

The winches 124, 125 may be controlled gears. The free end of each cable is wrapped about the winches and the winches are controlled to wind the cables 122, 123 up or down.

The cable assembly 121 further comprises a horizontal cable 126 extending between the vertical cables 122, 123. The horizontal cable 126 is coupled to each vertical cable by a wheel assembly 127. The wheel assembly 127 is moveable along the vertical cable 122, 123. As shown in the illustrated example, the cable assembly may comprise two, wheel assemblies 127, and a single wheel assembly being associated with a single horizontal cable.

The horizontal cable 126 coupled to the chassis 110 such that the chassis 110 is moveable on the façade and along the horizontal cable 126. The robot 100 can move in a cartesian approach i.e., an x and y direction. Vertical movement is achieved by the controller 130 activating the respective winch. The robot 100 is controlled to freely move along the horizontal cable 126. The robot can move along the façade using the locomotion arms 144-147 and the winches winding the cables upward or downward.

The controller 130 be configured to control the winches by a wireless signal. Alternatively, the winches may be manually controller. In a further alternative, each winch may comprise a separate controller that may be programmed with a specified route for the robot to move along the façade. The winches 124, 125 may be controlled to wind or unwind the cables to facilitate movement of the robot along the programmed path. The controller 130 may also be programmed with this route and control the locomotion arms 144-147 to move along the façade of the building according to the programmed path.

FIG. 14 illustrates a second example of a cable assembly 221. In this second example the cable assembly 221 comprises a cable 222. The cable assembly 221 further comprises a pair of winches 223, 224. The free ends of the cable being clamped in the winches 223, 224. The winches 223, 224 are configured to adjust the length of the cable 222. The winches 223, 224 are arranged in electrical communication with the controller 130. The controller 130 configured to operate the winches to vertically wind the cable upward or downward thereby allowing vertical movement of the robot 100.

The chassis 110 i.e., the robot 100 is suspended from the cable and moveable on the façade and along the cable. The robot 100 is freely moveable along the façade while being suspended. The controller 130 is configured to control the cable assembly 221 using a polar approach i.e., an R theta approach. The controller 130 may wirelessly communicate with the winches to operate the winches.

Alternatively, the winches may be manually controlled. In a further alternative the winches each may comprise a controller that may be programmed with a route for the robot. The winches are controlled to wind or unwind the cable to facilitate movement along the path. The controller 130 may control the locomotion arms 144-147 to move along the programmed path.

The robot 100 may be programmed to move along a predefine path on the building façade and perform maintenance tasks. The controller 130 is configured to store the programmed path and control the locomotion arms 144-147 to move the robot on the façade. The controller 130 may be further configured to control the one or more tools to perform predefined maintenance tasks. The maintenance tasks may be programmed e.g., as a servicing schedule or a maintenance schedule. The robot 100 may comprise a plurality of tools configured to allow the robot to perform multiple maintenance tasks, and wherein the plurality of tools comprise two or more of: a cleaning tool, an inspection tool, a repair tool.

In one example configuration the robot 100 may comprise at least one cleaning tool 200, at least one inspection 202 tool and at least one repair tool 204. The controller 130 may be in electrical communication i.e., electrically coupled to each of the tools. The controller 130 may be configured to receive data from the inspection tool and identify one or more defects based on processing the received data from the inspection tool 202. The controller 130 may be further configured to control operation of the cleaning tool 200 and the repair tool 204. The cleaning tool 200 and/or repairing tool 204 may be activated and controlled to address the one or more identified defects.

The cleaning tool 200 is a tool that is designed to clean and remove stains, dirt and other debris from a building façade without damaging the façade. The robot 100 may comprise one or more cleaning tools attached to the tool arms 140-143.

In one example the cleaning tool 200 comprises at least one of: a spray gun configured to spray a cleaning substance onto a portion of the building, a rolling wheel and a cleaning agent dispenser, an ultrasonic cleaning device configured to clean a portion of a building by applying ultrasonic waves, a dry ice blasting device configured to apply dry ice pellets using compressed air onto a portion of a building, a laser cleaning device configured to apply a focussed laser beam to a portion of a building.

The rolling wheel may comprise one or more rolling wheels i.e., one or more rollers. The rollers may be activated and deactivated by the controller 130. The controller 130 may be configured to control the cleaning agent dispenser to dispense cleaning agent and control the wheel to clean the area with the detergent. The robot may comprise adjustable rolling wheels that can adapt to different types of surfaces of the façade. The wheels maybe adjusted to provide the required level or pressure and traction to clean the façade.

In one example spray gun may be configured to spray a cleaning material or cleaning substance onto the façade. In one example the spray gun may comprise a water spray e.g., a water jet gun. The spray gun may comprise a high-pressure water jet that releases a high-pressure stream of water to remove dirt, grime and other contaminants from the façade. The spray gun may comprise a nozzle configured to pressurise water. Optionally, the pressure may be adjustable, e.g., by the controller 130. The delivered pressure may be adjusted based on the surface being cleaned and/or the amount of dirt. The spray gun is advantageous because it allows for targeted cleaning of specific areas, e.g., areas that are particularly dirty.

The ultrasonic cleaning device i.e., the ultrasonic cleaning tool, is configured to clean a façade or other building surfaces by applying high frequency sound waves. The ultrasonic cleaning device may comprise one or transmitters configured to transmit high frequency sound waves. In use, the ultrasonic cleaning device may be used on one arm and another arm may incorporate a cleaning solution dispenser configured to dispense cleaning solution e.g., detergent or surface cleaner. The ultrasonic cleaning device may be configured to apply high frequency waves to the cleaning solution. The ultrasonic waves create bubbles in the cleaning solution that clean a surface due to pressure differential created when the bubble collapses. The high frequency waves and resulting cavitation can also penetrate crevices and blind holes removing dirt that is difficult to reach. The ultrasonic cleaning device may be equipped for some specific situations such as cleaning smaller and more intricate parts of a building's façade or cleaning hard to reach parts.

Dry ice blasting can be useful for cleaning a variety of surfaces of a building. The dry ice blasting device is configured to use compressed air to accelerate small pellets of dry ice at high speeds. The surface is cleaned when the dry ice comes into contact with the surface being cleaned as the dry ice pellets cause surface to contract and break up thus helping removal of dirt. The dry ice blasting device may be particularly useful for cleaning delicate material such as marble as it provides a non-abrasive cleaning tool. The dry ice blasting device may be used for specific situation such as cleaning delicate or brittle material.

The laser cleaning device may be configured to apply a focussed laser beam onto a surface of the building to remove dirt, debris or other contaminants from the surface. The laser cleaning device may be particularly useful and effective on metal surfaces e.g., window frames. The laser device may also include one or more polishing tools that are used to polish metal surface following the laser cleaning.

The robot 100 may be equipped with the appropriate cleaning tool (or tools) based on the cleaning requirements, the specific areas and specific materials to be cleaned. Appropriate cleaning tools can be attached to the tool arms to achieve the required cleaning. The tools are easy to connect and disconnect allowing quick changes.

The robot 100 may be configured to be equipped with one or more inspection tools 202. The inspection tools may comprise one or more sensors i.e., transducers that are configured to identify one or more defects or faults on a building.

The inspection tool 202 may comprise at least one of: an infrared ray device configured to utilise infrared signals to identify one or more defects on a portion of building, a water jet device configured to utilise a water jet to identify one or more defects, a caulking test device configured to identify a defect in a caulking material used on a portion of a building façade, an electrical scanning device configured to measure an electrical property and the electrical scanning device configured to detect and measure deterioration in a portion of a façade of the building, a laser device configured to use a laser and detect a fault in a portion of the façade of the building, a mechanical vibration device configured to apply vibrations to a portion of the façade and determine one or more defects based on the measured vibrations, a pH detector configured to sense pH of a portion of a façade and determine a defect based on the detected pH, a chemical detection device configured to detect one or more chemicals and detect one or more defects based on the detected chemicals.

The caulking test device may be used for measuring the elasticity of rubber or other caulking materials used in building facades. The caulking test device may comprise a test arm that is configured to apply a controlled force on caulking material. The caulking test device may comprise a sensor that measures the amount of deflection or deformation that occurs. The controller 130 may receive the measured signals and determine the elasticity of the caulking material based on the deformation or deflection.

The water jet device may be used to test for leaks in the building façade. The water jet device may comprise an arm with a nozzle and pipes. The jet device is configured to apply a high-pressure jet to simulate rain or other water sources. By directing the water jet at different areas of the façade inspectors may observe any water ingress (i.e., water penetration) issues. This type of testing can help identify leaks that are not visible and can be used on complex or irregular shapes of the façade.

The infrared ray device may be configured to use infrared technology to inspect the peel off or hollow mosaic tile areas or other façade defects. Infrared technology enables detection of defects or damage to the façade that is not visible to the naked eye. In one example the infrared device may comprise an infrared camera that is configured to detect defects by measuring the temperature difference between the affected areas and unaffected areas. The infrared device can be used to identify moisture intrusion, heat loss or other issues that may be indicative of damage.

The electrical scanning device may be used to determine the deterioration of building façade materials. The electrical scanning device may apply electric pulses to the façade and measure the resistance, capacitance and inductance of a material. The controller may detect the measured resistance or capacitance or inductance and determine the condition of the material. Different materials have different electrical properties and as these materials deteriorate, their electrical properties change. The scanner device can measure the change in electrical properties. The controller 130 may be configured to identify deterioration of a material based on the change in the electrical properties.

The laser device may comprise a laser gun configured to apply a laser and measure the reflected signal to identify depth of scratches in the coating e.g., the UV coating of a façade. The size and depth of the scratches can be determined in the controller 130 thereby allowing an operator or inspector to determine if the UV coating of a building needs replacement.

The mechanical vibration device is configured to detect loose or hollow areas in building facades. The vibration device comprises an actuator e.g., a piston that vibrates the façade at different frequencies of mechanical vibrations. The vibration device may further include a vibration sensor to sense vibrations, in particular amplitude and/or frequency and determine hollow gaps or loose sections based on the change in the frequency and/or amplitude of the applied vibrations. For example, a solid area will produce a sharp vibration while a hollow area will produce a dull vibration.

The pH value detector may be configured to measure the pH of the façade or other surfaces. The controller 130 may be configured to process the measured pH values. A change in pH level i.e., a pH above or below a threshold can represent damage to the façade or deterioration of the façade material due to change in the acidity or alkalinity of the façade.

The chemical detection device may comprise a spray nozzle that is used to apply various chemical solutions to portions of the façade for specified tests. The detector further comprises one or more chemical sensors to measure or detect various chemicals. Alternatively, the chemical detection device may comprise a camera to detect visual changes due to the chemical. Alternatively, the camera may be a camera mounted on the chassis as described herein. The chemical detection device may be used to detect rust or mould or algae.

The controller 130 may be configured to receive signals or measurements from the one or more inspection tools. The controller 130 may further be configured to process the received measurements and determine one or outputs or one or more parameters as described earlier. The controller 130 may be further configured to store the measurements and/or the parameters. The measurements and/or parameters calculated may be transmitted to a computing system or to one or more devices associated with building inspectors or engineers for further assessment. The controller 130 may further be configured to transmit the measurements and/or parameters to a computing system 310 via the wireless communication module 136.

The controller 130 may be configured to process the data or measurements received from the one or more inspection tools. The controller 130 may be configured to process the data using any suitable signal processing techniques such as for example, Fourier transforms, linear regression analysis, wavelet transform, filter bank, nonlinear regression (e.g., Wigner-Ville transforms). The processor 132 may be programmed to apply the appropriate signal processing technique. The specific signal processing technique will be selected based on the type of inspection tool being utilised.

The controller 130 may be configured to receive measured data (i.e., measured signals) from the one or more inspection tools 202 and process the received data. The controller 130 may be configured to identify one or more defects identified based on the received data from the inspection tool. The one or more defects may be any one or more of: cracks in the façade, gaps between glass and windows, or gaps between a window frame and the building façade, aging of the façade, scratches or cracks in window frames or window glass, leaks in the building façade or window frames, peeling of a façade, deformation of the façade, deterioration of the façade material or window frame material or glass, damage to UV coating of the façade, loose or hollow areas in the building façade, rust on the façade or window frames, change in acidity or alkalinity of the façade material, or mould or algae growth on the façade or window frame or glass. The particular defect or fault is based on the type of inspection tool that is used

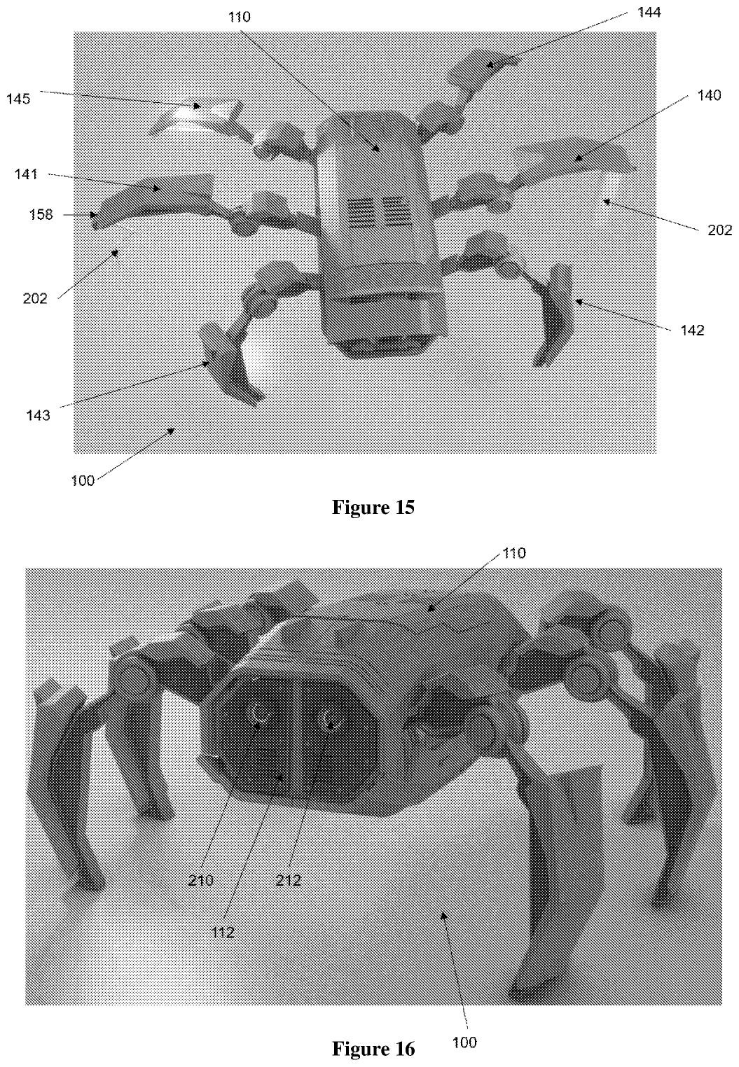

FIG. 15 illustrates one configuration of the building maintenance robot 100. The robot 100 comprises six legs 140, 141, 142, 143, 144, 145. In the illustrated configuration the robot 100 comprises four locomotion arms 142, 143, 144, 145, and two tool arms 140, 141. In the illustrated configuration the tool arms 140, 141 are located in between pairs of locomotion arms 142, 143 and 144, 145. In the example of FIG. 15, an inspection tool is mounted on each tool arm 140, 141. As shown in the example of FIG. 15, an electrical scanning device is mounted to arm 141 and a laser device is mounted to arm 140. The tool arms 140, 141 may be operated by the controller 130 to position the inspection tools into an appropriate operational position. The locomotion arms 142-145 are controlled as described earlier to move the robot 100 along the façade of the building.

The building maintenance robot may comprise at least one camera 210. The camera 210 may be mounted on the chassis 110 and configured to capture one or more images of a portion of the building. The camera 210 may be electrically coupled to the controller 130 and transmit captured images to the controller 130. The camera 210 may be configured to capture one or more still images. The camera may be configured to capture a video stream or may be configured to capture a combination of still images or a video stream. The camera 210 may be activated manually by a user e.g., by a remote signal, or the camera 210 may be controlled to automatically capture images or a video stream by the controller 130.

The camera 210 may be an inspection tool. In use, the camera 210 may be configured to capture one or more images of a portion of the façade of the building. The controller 130 may be configured to receive the one or more captured images of a portion of the façade of the building from the camera 210. The controller 130 may be configured to apply chromo-inspection technique or object identification techniques to detect one or more defects visible in the one or more captured images. The controller 130 may be configured to detect a plurality of wavelengths within the captured images to identify one or more defects in a portion of the façade of the building.

In an alternative configuration one or more cameras may be attached to the one or more tools arms. For example, a single camera may be mounted to or removably attached to a tool arm of the robot 100.

The identified defects may be stored in the memory unit 134. Optionally, the identified defects may be transmitted to a computing system 310. The controller 130 may further be configured to identify one or more obstacles. The camera 210 and the images or video stream may be used to navigate the robot 100 about the façade.

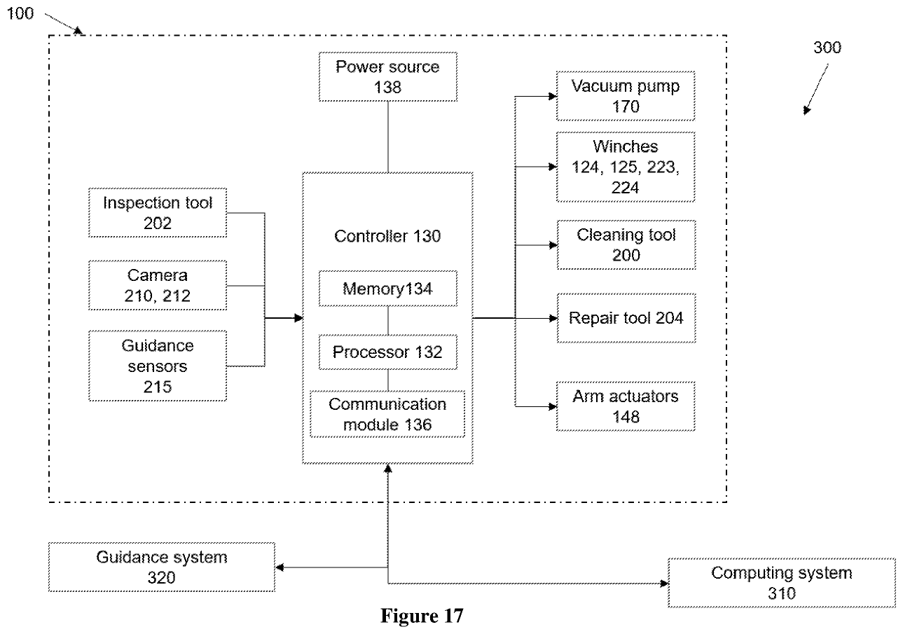

FIG. 16 shows an example form of the building maintenance robot 100 that includes a pair of cameras 210, 212. The pair of cameras are mounted on the chassis 110. In the illustrated form of FIG. 16, the cameras 210, 212 are mounted on a front face 112 of the chassis 110. The cameras 210, 212 being on the front face 112 allow the cameras a clear line of sight. The cameras 210, 212 may each be mounted on a rotatable mount that may be omni directionally rotatable. Additionally, the pair of cameras may also being spaced apart from each other at a predefined distance. The pair of cameras 210, 212 may be configured to capture a video stream and transmit video stream to the controller 130. The controller 130 may be configured to receive the video stream. The controller 130 may be configured to process the video stream to identify features of the façade. For example, the controller may be configured to identify one or more features on the façade by applying an object detection process. The controller 130 may be further configured to identify obstacles within the video stream.

The controller 130 may be configured to control the locomotion system 120 to move the robot along the façade of the building while avoiding the obstacles. The controller 130 may additionally be configured to control the locomotion system 120 to move the robot 100 along the façade. The robot 100 may be controlled to avoid obstacles and/or move toward one or more of the features for further analysis. The controller 130 may be configured to detect one or more defects based on the identified one or more features of the façade.

The building robot 100 may comprise one or more repair tools 204. The one or more repair tools may be removably attached to one or more of the tool arms of the robot. The repair tool 204 may comprise at least one of: a caulking gun configured to apply a filler material to a portion of a façade of the building to fill in cracks or gaps identified on the façade or gaps between the window frame and façade, a polishing tool configured to polish the façade or window frames to remove rust, dirt or other surface contaminants, a glass buffing tool configured to buff glass to repair scratches or marks on a window glass, or a chemical spray device to spray cleaning, chemicals e.g. antimicrobial chemicals etc.

FIG. 17 illustrates a block diagram of the robot 100 including the controller 130 and the components the controller 130 interacts with. As can be seen in FIG. 17, the controller 130 receives input signals from various input devices such as for example the inspection tool(s), cameras and other sensors e.g., guidance sensors. The controller 130 is configured to process the input signals and control one or more actuators such as for example the cleaning tool(s), repair tool(s), arm actuators and winches or other components of the locomotion system.

The building maintenance robot 100 comprises at least one power source 138 disposed on the chassis 110. The power source is sufficient to power the robot 100 for an extended period without interruptions. For example, the power source 138 is of sufficient capacity to last for at least five hours or longer. The power source 138 may be electrically coupled to the controller 130. The controller 130 may be configured to manage power supplied to the cleaning tools 200, inspection tools 202, repair tools 204 and other components such act

In one example the power source 138 may be a rechargeable power source. The power source 138 may be a battery e.g., a rechargeable battery. In one example the rechargeable battery 138 may be a lithium rechargeable battery. Lithium batteries are advantageous because they have high energy density, long cycle life and low self-discharge rates. The battery 138 allows the robot 100 to be portable and freely moveable on the façade. The lithium battery 138 is also lightweight and small is size improving portability and moveability of the robot 100. Lithium batteries can be quickly and efficiently recharged which allows the robot 100 to be ready for use within a short amount of time. This is advantageous because the robot 100 can be cycled multiple times quickly within minimal downtime.

In another option the power source 138 may be a battery that includes a charging coil for inductive charging. The battery is charged by inductive coupling the charging coil with a power coil. The power coil may be connected to a power source and the charging coil inductively couples to the power coil. Power induced in the charging coil is transmitted to the power source to charge the power source. An inductive charging power source is advantageous as it reduces the need for any wired connections providing a flexible charging solution.

In another alternative form, the power source 138 may be coupled to an electric cable. The electric cable may supply power to power the robot 100. The cable may also comprise a data line that transmits data from the controller 130 to the computing system 310.

In another alternative form the locomotion system 120 may comprise one or more propellers. The robot 100 may be a drone. The drone robot may be configured to fly around the façade. Optionally the robot may comprise one or more propellers and locomotion arms as described earlier to allow the robot to fly to a desired or defined location on the façade and then move along the façade using the locomotion arms 144-147 while performing the specified maintenance tasks.

Alternatively, the robot may be equipped with a drone that can fly above the façade and provide an aerial view of the façade to identify areas that require maintenance or servicing. In this alternative the robot may comprise one or more cameras for visual inspections from the air. The camera may identify areas that require cleaning or spraying. The images captured by the camera may be transmitted to a computing system via the wireless communication module 136.

The use of a drone is safer since there is no need for operators to be suspended on tall buildings. The drone further may be able to identify hazards earlier and from a distance without putting a human in harm's way. The use of drone i.e., the robot being a drone or used in combination with a drone makes the building maintenance robot safer, more efficient and provides more accurate identification of requirements of maintenance. Further the robot can access more areas of a building including the hard-to-reach areas providing a better servicing.

The cleaning, inspection and repair of buildings, in particular skyscrapers are inherently hazardous. The robot may comprise safety wires attached to the robot 100. The safety wires may be coupled to the building e.g., to the roof of the building the robot is operating in. The safety wires may be in addition to the cables and provide an extra layer of protection in case there is malfunction e.g., in the suction cups or in battery etc. The cables 122, 123 may also function as safety wires. The winches may comprise locks in case there is a malfunction. The safety wires prevent the robot from falling from the building and injuring pedestrians or damage to the robot. The robot 100 may also include airbags or other padding to reduce damage.

The robot 100 may further comprise one or more guidance sensors 215. The guidance sensors 215 may be used as part of the locomotion system. The guidance sensors 215 may be used in conjunction with cameras 210, 212 to detect features and obstacles on the building façade. The guidance sensors 215 may be electrically coupled to the controller 130 and may transmit sensor signals to the controller 130. The guidance sensors 215 may comprise a laser or infrared sensor or a proximity sensor or other sensors used to identify obstacles. The controller 130 may be configured to control the locomotion system 120 e.g., the locomotion arms to avoid obstacles detected by the guidance sensors.

FIG. 17 further illustrates a building maintenance system 300. The system 300 comprises a building maintenance robot 100 and a computing system 310. The computing system 310 is in electronic communication with the robot 100. The computing system 310 is configured to receive data regarding the one or more maintenance tasks performed by the robot 100. The computing system configured to perform one or more tasks.

The computing system 310 may be configured to perform machine learning analysis on the received data to learn from maintenance tasks performed and adjust the types or frequency of maintenance tasks. The computing system 310 may be configured to generate a maintenance schedule defining the number of maintenance tasks to be performed, frequency of these tasks, and location of maintenance tasks on the building façade. Optionally, the computing system 310 may be configured to execute a pre-programmed maintenance schedule or the generated maintenance schedule. The computing system 310 may be configured to generate mathematical models that simulate the deterioration rate of the building façade based on the received maintenance task data. Additionally, the computing system 310 may be configured to identify building façade deterioration patterns based on the received maintenance task data, and/or identify components of the façade that require the most maintenance,
calculate costs for performing maintenance and determine the most cost-effective maintenance schedule. The computing system 310 and the tasks performed enable prediction of future conditions and identify façade deterioration patterns which can be used to forecast future condition changes. The computing system 310 can be used to prolong the lifespan of the building and reduce maintenance costs by applying various Al processing.

The computing system 310 may comprise a remote server in wireless communication with the robot. Alternatively, computing system 310 and its function may be incorporated into the controller 130 of the robot.

Optionally, the system 300 may further comprise a guidance system 320. The controller 130 may be configured to communicate with the guidance system 320 via the wireless communication module 136. The guidance system 320 may be for example a GPS system (global positioning system). The guidance system 320 may provide information regarding the position of the robot on the building. This position i.e., location information may be transmitted to the computing system 310. The controller 130 may be configured to use the position information to move the robot 100 according to pre-set or user defined paths along the building façade.

The system 300 may comprise a plurality of building maintenance robots that are arranged in communication with the computing system 310. The collected data from the robot 100 (or robots) may be stored in a private cloud or data centre servers. The computing system 310 may comprise private cloud or data centre servers. Optionally, the system 300 may comprise a mobile device e.g., a smartphone. The smartphone may comprise an app that may receive data e.g., analytics from the computing system 310. The app may present overall performance of the robot 100 on the mobile device. A user e.g., a maintenance operator can send instructions via the mobile device. The user may further provide maintenance schedules and/or preventative maintenance or define a maintenance schedule that can be transmitted to the computing system 310. The computing system 310 may transmit the user maintenance schedule or maintenance schedule to the robot 100 and the robot 100 may automatically move around the façade.

The building maintenance robot 100 as described herein is advantageous because it offers a safer device for performing building maintenance tasks e.g., cleaning, inspection, repair, than the current practice of using human operators. Performing maintenance tasks on skyscrapers can be very dangerous due to risk of injury or death from falling. The robots provide an inanimate device for performing dangerous tasks.

The building robot 100 as described herein further provides a more efficient system for performing maintenance tasks on a building. The robot can work with no breaks and is generally faster than human operators. The robot 100 further provides improved accessibility to areas that can be difficult or sometimes impossible for human operators to access. The robot 100 is designed to navigate these challenging environments and access hard to reach areas ensuring a higher standard of maintenance. Further accessing the challenging environments reduces the risk for any human operators to put themselves in harm's way. These hard-to-reach places can also be cleaned, inspected and if needed repaired thereby improving the quality and lifespan of the building.

The robot 100 can often be more cost effective than human operators over the long run as the robot 100 does not require a salary, benefits, insurance or breaks. Insurance premiums for human operators can be high due to the hazardous work environment. Such costs for a robot can be comparably cheaper.

The robot 100 is also advantageous as it can be programmed to perform maintenance tasks (e.g., cleaning, inspection, repair etc.) with a high degree of consistency, ensuring every part of the building is well maintained. The robot can be pre-set with a maintenance schedule that the robot may autonomously execute leading to improved maintenance of the building. The building maintenance robot and system are also advantageous since data is collected by the robot. The collected data, regarding maintenance tasks, can be processed and can be used to calculate preventative maintenance requirements and maintenance schedules This can improve the appearance of the building and extend its lifespan.

For the purposes of this document, the term building may also include building like structures which has characteristics of buildings and require regular maintenance. These include large vehicles, including ships, telecommunication towers, large statues, that may have a large façade that requires maintenance. Ships for example, such as passenger cruiser liners will have facades and ship bodies (hulls) that require maintenance, and therefore examples of the building maintenance robot may be used to perform similar maintenance tasks.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The term “comprising” (and its grammatical variations) as used herein are used in the inclusive sense of “having” or “including”and not in the sense of “consisting only of”.

Any reference to prior art contained herein is not to be taken as an admission that the information is common general knowledge, unless otherwise indicated.

1. A building maintenance robot comprising:
a chassis,
a locomotion system coupled to the chassis, the locomotion system configured to facilitate movement of the robot,
one or more tools coupled to the chassis, the one or more tools configured to allow the robot to perform one or more maintenance tasks,
a controller in electrical communication with the locomotion system and the one or more tools, the controller configured to:
control the locomotion system to cause movement of the robot, and
control the one or more tools to perform the one or more maintenance tasks.

2. A building maintenance robot according to claim 1, wherein the one or more tools comprises one or more of:
a cleaning tool configured to clean a portion of a building,
an inspection tool configured to perform one or more inspections to identify one or more defects on a portion of a building, and
a repair tool configured to perform one or more repair functions on a portion of a building.

3. A building maintenance robot according to claim 2, wherein the robot comprising a plurality of tools configured to allow the robot to perform multiple maintenance tasks, and wherein the plurality of tools comprise two or more of: a cleaning tool, an inspection tool, a repair tool.

4. A building maintenance robot according to claim 3, comprising at least one cleaning tool, at least one inspection tool and at least one repair tool, and the controller is configured to receive data from the inspection tool and identify one or more defects based on processing the received data from the inspection tool, and the controller further configured to control operation of the cleaning tool and the repair tool.

5. A building maintenance robot according to claim 4, wherein the cleaning tool comprises at least one of:
a spray gun configured to spray a cleaning substance onto a portion of the building,
a rolling wheel and a cleaning agent dispenser,
an ultrasonic cleaning device configured to clean a portion of a building by applying ultrasonic waves,
a dry ice blasting device configured to apply dry ice pellets using compressed air onto a portion of a building,
a laser cleaning device configured to apply a focussed laser beam to a portion of a building.

6. A building maintenance robot according to claim 5, wherein the inspection tool comprises at least one of:
an infrared ray device configured to utilise infrared signals to identify one or more defects on a portion of building,
a water jet device configured to utilise a water jet to identify one or more defects,
a caulking test device configured to identify a defect in a caulking material used on a portion of a building façade,
an electrical scanning device configured to measure an electrical property and the electrical scanning device configured to detect and measure deterioration in a portion of a façade of the building,
a laser device configured to use a laser and detect a fault in a portion of the façade of the building,
a mechanical vibration device configured to apply vibrations to a portion of the façade and determine one or more defects based on the measured vibrations,
a pH detector configured to sense pH of a portion of a façade and determine a defect based on the detected pH,
a chemical detection device configured to detect one or more chemicals and detect one or more defects based on the detected chemicals.

7. A building maintenance robot according to claim 6, comprising at least one camera, the camera mounted on the chassis and configured to capture one or more images of a portion of the building; and wherein
the camera is an inspection tool,
the camera is arranged in electrical communication with the controller,
the camera configured to capture one or more images of a portion of the façade of the building,
the controller configured to receive the one or more captured images of a portion of the façade of the building from the camera,
the controller configured to apply chromo-inspection technique or object identification techniques to detect one or more defects visible in the one or more captured images.

8. (canceled)

9. A building maintenance robot according claim 7, wherein the controller is configured to detect a plurality of wavelengths within the captured images to identify one or more defects in a portion of the façade of the building.

10. A building maintenance robot according to any claim 9, comprising a pair of cameras, the pair of cameras are mounted on a front portion of the chassis, the pair of cameras being spaced apart from each other at a predefined distance and, wherein the pair of cameras is configured to capture a video stream and transmit video stream to the controller,
the controller is configured to receive the video stream, process the video stream to identify features of the façade and identify obstacles within the video stream, control the locomotion system to move the robot along the façade of the building based on the identified features and obstacles, or detect one or more defects based on the identified one or more features of the façade.

11. (canceled)

12. A building maintenance robot according to claim 10, wherein the controller is configured to:
receive measured data from the inspection tool,
process the received data,
identify one or more defects identified based on the received data from the inspection tool, wherein the one or more defects may be any one or more of:
cracks in the façade,
gaps between glass and windows, or gaps between a window frame and the building façade,
aging of the façade,
scratches or cracks in window frames or window glass,
leaks in the building façade or window frames,
peeling of a façade,
deformation of the façade,
deterioration of the façade material or window frame material or glass,
damage to UV coating of the façade,
loose or hollow areas in the building façade,
rust on the façade or window frames,
change in acidity or alkalinity of the façade material,
mould or algae growth on the façade or window frame or glass.

13. A building maintenance robot according to claim 12, wherein the repair tool comprises at least one of:
a caulking gun configured to apply a filler material to a portion of a façade of the building to fill in cracks or gaps identified on the façade or gaps between the window frame and façade,
a polishing tool configured to polish the façade or window frames to remove rust, dirt or other surface contaminants,
a glass buffing tool configured to buff glass to repair scratches or marks on a window glass.

14. A building maintenance robot according to claim 13, comprising:
a plurality of arms,
each arm being moveably connected to the chassis and extending outward from the chassis,
the cleaning tool being removably connected to or removably mounted on an arm,
the inspection tool being removably connected to or removably mounted on an arm, and
the repair tool being removably connected to or removably mounted to an arm.

15. A building maintenance robot according to claim 14, wherein each arm is an articulating arm configured to articulate in multiple directions, and wherein each arm comprises at least two joints, a first joint connecting a first arm member to the chassis and a second joint connecting the first arm member to a second arm member, the second arm member being moveable relative to the first arm member by the second joint.

16. (canceled)

17. A building maintenance robot according to claim 15, wherein the second arm member of one or more of the plurality of arms comprising a tool mount to removably receive one of: the cleaning tool, inspection tool or repair tool.

18. A building maintenance robot according to claim 17, comprising at least two locomotion arms moveably coupled to the chassis,
the locomotion system comprising the two locomotion arms,
the controller configured to control movement of the locomotion arms, such that in use the controller configured to alternatingly providing a drive signal to the locomotion arms to cause the locomotion arms to move in an alternating manner, and
wherein alternating movement of the locomotion arms cause the robot to move along a façade of the building.

19. A building maintenance robot according to claim 18, wherein each locomotion arm comprises a foot and an attachment mechanism positioned on the base of the foot, in use, the attachment mechanism attaching each locomotion arm to the façade of the building as the robot is moving across the façade.

20. (canceled)

21. A building maintenance robot according to claim 19, comprising at least six arms attached to the chassis and extending outward from the chassis,
four of the at least six arms are locomotion arms,
two arms of the at least six arms comprise tool mounts to removably mount or attach a tool to each of the two arms, wherein the tool comprises one of a cleaning tool, an inspection tool or a repair tool.

22. A building maintenance robot according to claim 21, wherein in use the controller is configured to:
control movement of a first pair of diagonally opposite arms while maintaining the second pair of diagonally opposite arms stationary, and
alternatively control movement of the first pair of diagonally opposite arms and second pair of diagonally opposite arms, and wherein each of the locomotion arms comprises a foot with a plurality of suction cups disposed on each foot,
the suction cups are fluidly coupled to a vacuum pump system that is configured to create to suction in the suction cups when switched on,
the controller arranged in electrical communication with the vacuum pump system, and the controller configured to activate the vacuum pump system to create suction in the suction cups for the stationary diagonally opposite arms and deactivate the vacuum pump system to switch off suction in the suction cups for the diagonally opposite pair arms that are moving.

23. (canceled)

24. (canceled)

25. A building maintenance robot according to claim 22, wherein the locomotion system further comprises:
a cable assembly including:
a first vertical cable and a second vertical cable,
a first winch and a second winch, the first cable coupled to the first winch and the second cable coupled to the second winch, and
a horizontal cable extending between the vertical cables, the horizontal cable coupled to each vertical cable by a wheel that is moveable along the vertical cable,
the horizontal cable coupled to the chassis such that the chassis is moveable on the façade and along the horizontal cable,
the controller configured to: control the winch to raise or lower the cables to move the robot vertically.

26. (canceled)

27. (canceled)

28. A building maintenance system comprising:
a building maintenance robot as per claim 1,
a computing system in electronic communication with the robot, the computing system configured to receive data regarding the one or more maintenance tasks performed by the robot,
the computing system configured to perform at least one or more of:
machine learning analysis on the received data to learn from maintenance tasks performed and adjust the types or frequency of maintenance tasks,
generate a maintenance schedule defining the number of maintenance tasks to be performed, frequency of these tasks, and location of maintenance tasks on the building façade,
execute a pre-programmed maintenance schedule or the generated maintenance schedule,
generate mathematical models that simulate the deterioration rate of the building façade based on the received maintenance task data,
identify building façade deterioration patterns based on the received maintenance task data,
identify components of the façade that require the most maintenance,
calculate costs for performing maintenance and determine the most cost-effective maintenance schedule.

29. (canceled)

30. (canceled)
